(19) United States
(12) Patent Application Publication
(10) Pub. No.: US 2011/0204069 A1
(43) Pub. Date: Aug. 25, 2011

(54) THERMALLY INSULATED OPTICAL EFFECT CONTAINER AND METHOD OF FORMING SAME

(76) Inventors: Jonathan Moon, Auckland (NZ); David E. Roberts, Hillsboro, WI (US)

(21) Appl. No.: 13/056,369

(22) PCT Filed: Jul. 30, 2009
(86) PCT No.: PCT/US2009/052284

§ 371 Date: Apr. 13, 2011

Related U.S. Application Data
(60) Provisional application No. 61/084,868, filed on Jul. 30, 2008.

(51) Int. Cl. B65D 8/04; B23P 17/04

(52) U.S. Cl. 220/660; 29/527.1

(57) ABSTRACT

An optical effect container (10) that includes a preformed container (12) is disclosed. The preformed container includes a base and a side wall connected to the base. The side wall defines a container opening (24). The optical effect container also includes an optical effect array (14) adjacent the side wall and a gap (44) defined between the preformed container and the optical effect array. In addition, a method of forming the optical effect container is also disclosed.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The invention relates to optical effect containers, such as food and beverage containers, and particularly to thermally insulated optical effect containers. The invention also relates to methods of fabricating optical effect containers.

### BACKGROUND OF THE INVENTION

Printed autostereoscopic articles such as lenticular, barrier strip, and fly's-eye articles, have been used for some time to provide optical effects that are not possible for most two-dimensional images. For example, optical effect articles may provide a three-dimensional appearance or motion of an image. Optical effect articles achieve such effects by providing a structure that alters the path of light as it passes from the image to a viewer's eye.

In the past, optical effect articles have typically been used to provide an aesthetically appealing image to a viewer. For example, optical effect articles have been used to provide appealing book covers, stickers, trading cards, mouse pads, buttons, postcards, beverage coasters, puzzles, magnets, placemats, postage stamps, and other similar objects. In addition, optical effect materials have gained popularity as a cover for souvenir containers such as beverage cups or popcorn containers. Further still, optical effect materials have also gained popularity in recent decades in advertising due to the material's ability to provide an appealing image. In some cases, such as beverage cups, for example, an optical effect material can be used to provide both an appealing souvenir and an advertisement.

However, current optical effect containers have simple designs that perform poorly in some aspects. For example, some current optical effect containers are formed by inserting an optical effect material into an injection molding die and thereafter forming a container adjacent the optical effect material. This process results in a thin, single-layer component in which the container is completely bonded to the optical effect material. In addition, this process requires that the optical effect material and the container are similar materials in order to bond, thereby limiting the number of types of containers that may be made. As another example, some current optical effect containers are formed by subjecting the optical effect material to a process originally used with a conventional container-forming material, such as paper. This process results in a thin, single-layer component in which the optical effect material completely forms the container. The dimensions of the aforementioned containers provide objects that have relatively low thermal resistance despite being formed of plastic, a material that is a reasonable thermal insulator. As a result, the aforementioned containers, although aesthetically appealing, are not adequate for insulating hot or cold substances, especially in stadium or other outdoor environments. Therefore, some consumers would prefer a more thermally insulated container over a single-layer design.

Considering the limitations of previous optical effect containers, a design is needed that has improved thermal resistance properties.

### SUMMARY OF THE INVENTION

In some embodiments, the present invention provides an optical effect container that includes a preformed container. The preformed container includes a base and a side wall connected to the base. The side wall defines a container opening. The optical effect container also includes an optical effect array adjacent the side wall and a gap defined between the preformed container and the optical effect array.

In some embodiments, the present invention provides a method of forming an optical effect container including the steps of forming a container having an outer surface, providing an optical effect array, positioning the optical effect array adjacent the outer surface, securing a portion of the optical effect array to the outer surface; and forming a gap between the optical effect array and the outer surface.

The foregoing and other objects and advantages of the invention will appear in the detailed description that follows. In the description, reference is made to the accompanying drawings that illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1 is a perspective view of an optical effect container of the present invention;

FIG. 2 is a sectional view of the optical effect container of FIG. 1;

FIG. 3 is a sectional view of an embodiment of the optical effect container that includes a base ridge;

FIG. 4 is a sectional view of an embodiment of the optical effect container that includes an array fold;

FIG. 5 is a partial sectional view of an embodiment of the optical effect container that includes an adhesive;

FIG. 6 is a partial sectional view of an embodiment of the optical effect container that includes a lower stepped section;

FIG. 7 is a cross-sectional view of an embodiment of the optical effect container illustrating a seam of the container and vertical ridges;

FIG. 8 is a cross-sectional view of an embodiment of the optical effect container illustrating a seam of the container;

FIG. 9 is a perspective view of an embodiment of a preformed container of the optical effect container having vertical ridges;

FIG. 10 is a perspective view of an embodiment of the preformed container having horizontal ridges;

FIG. 11 is a perspective view of an embodiment of the preformed container having diagonal ridges;

FIG. 12 is a partial sectional view of an embodiment of the optical effect container that includes an upper stepped section;

FIG. 13 another partial sectional view of an embodiment of the optical effect container that includes an upper stepped section;

FIG. 14 is a side view of an optical effect array of the optical effect container illustrating adhesive regions on an array inner surface;

FIG. 15 is a side view of an embodiment of the preformed container having a recessed surface;

FIG. 16 is a side view of an embodiment of the preformed container having an upper stepped section;

FIG. 17 is a side view of an embodiment of the preformed container having an intermediate stepped section; and

FIG. 18 is a side view of an embodiment of the preformed container having two intermediate stepped sections.

### DETAILED DESCRIPTION OF THE PREFERRED EMBODIMENT

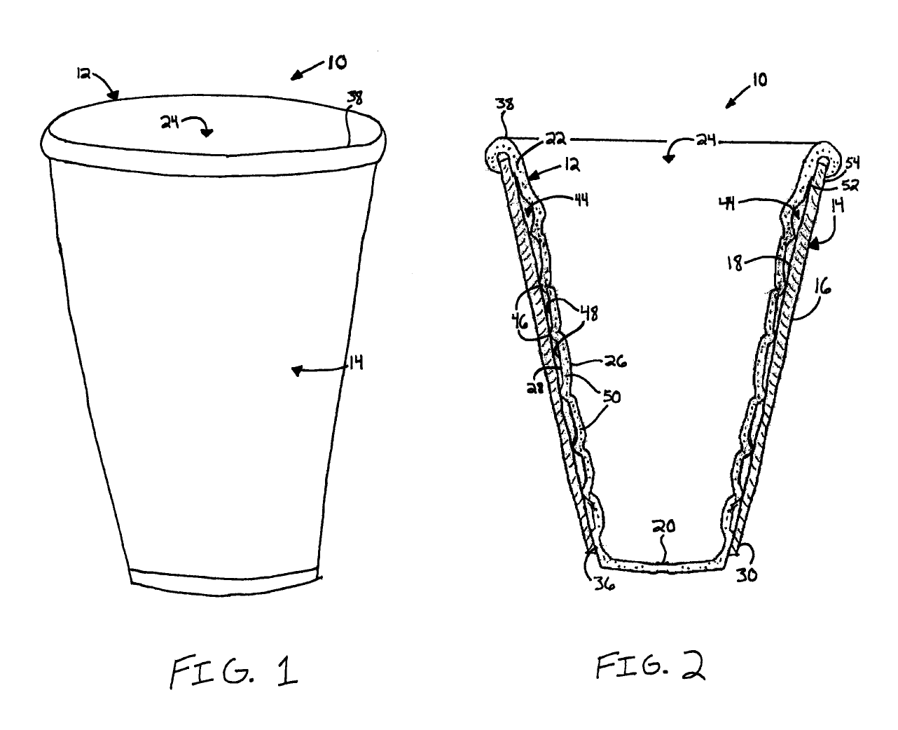

Referring now to the figures and specifically referring to FIG. 1, the present invention provides a container 10 that displays an optical effect and thermally insulates substances within the container 10. As shown in the figures, the optical effect container 10 may be axisymmetric, although other shapes are also possible. The container 10 includes a preformed container 12 that accommodates a substance and an optical effect array 14 adjacent the preformed container 12. The optical effect array 14 is preferably a lenticular material including the same components and constructed in the same manner as lenticular materials known to those skilled in the art. However, other types of lenticular materials as well other types of optical effect arrays, such as barrier strip articles, fly's-eye arrays, and the like, may be used. As such, and referring to FIGS. 2-4, the optical effect array 14 includes an array outer surface 16 through which an optical effect is displayed. The optical effect array 14 also includes an array inner surface 18 that is adjacent the preformed container 12.

Still referring to FIGS. 2-4, the preformed container 12 may be an opaque or clear component. The preformed container 12 may be opaque white, as those skilled in the art will appreciate, to assist in providing an optical effect in conjunction with the optical effect array 14. The preformed container 12 includes a base 20 and one or more side walls 22 connected to the base 20. The side wall 22 defines a container opening 24 through which substances may enter and exit the container 10. Substances within the container 10 are positioned adjacent a side wall inner surface 26. The side wall 22 also includes a side wall outer surface 28 to which the array inner surface 18 is adjacent.

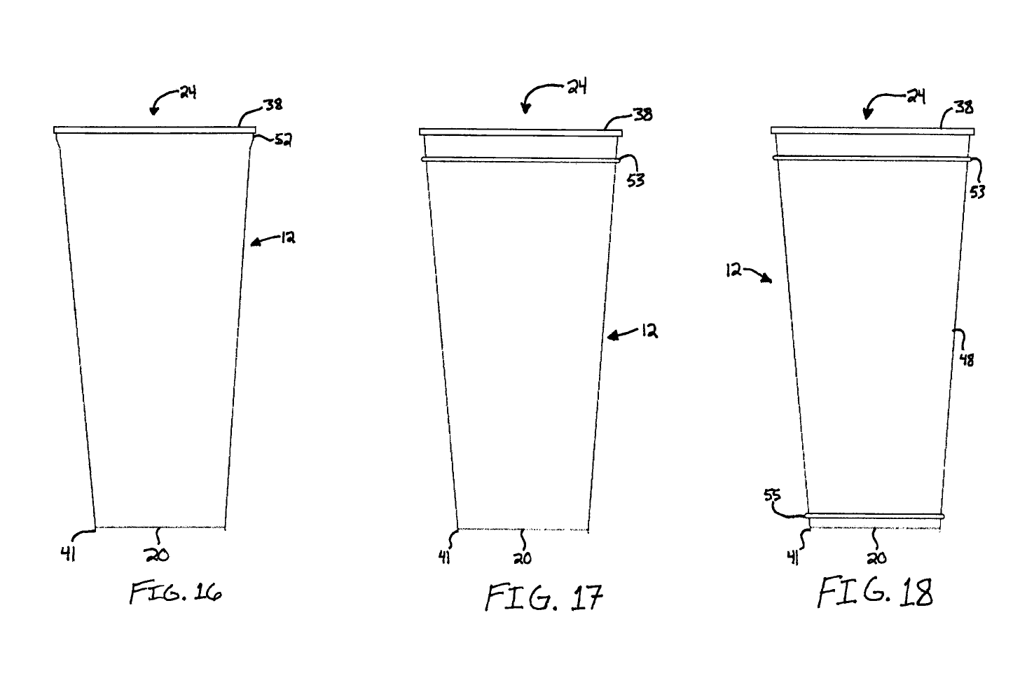

At least a portion of the side wall outer surface 28 and the array inner surface 18 are preferably connected to prevent the preformed container 12 and the optical effect array 14 from separating. A number of methods may be used to connect the preformed container 12 and the optical effect array 14. For example, the preformed container 12 and the optical effect array 14 may be connected by an adhesive, ultrasonic welding, or pressure fitting. Referring to FIGS. 2, 4 and 15, an array bottom portion 30 or an array fold 32 of the optical effect array 14 may be adhered, ultrasonically welded, or pressure fitted to a lower stepped section 36 proximate the base 20. Referring to FIG. 5, a plurality of adhesive regions, such as beads or lines 34 may connect the side wall outer surface 28 and the array inner surface 18. Referring to FIG. 6, the lower stepped section 36 extends outwardly relative to the side wall inner surface 26 and may engage an end of the optical effect array 14. The array bottom portion 30 may also be adhered, ultrasonically welded, or pressure fitted to the preformed container 12 in the configuration shown in FIG. 6. Referring to FIGS. 7 and 8, a portion 40 of the preformed container 12 may be adhered or ultrasonically welded to the optical effect array 14 proximate a seam 42 of the optical effect array 14. This connection may extend over the entire height of the container 10 or only part of the height of the container 10. Referring to FIGS. 12, 13, and 15-18, the preformed container 12 may include an upper stepped section 52 or intermediate stepped sections 53 and 55 that extend outwardly from the side wall inner surface 26 to provide a pressure fit with the optical effect array 14.

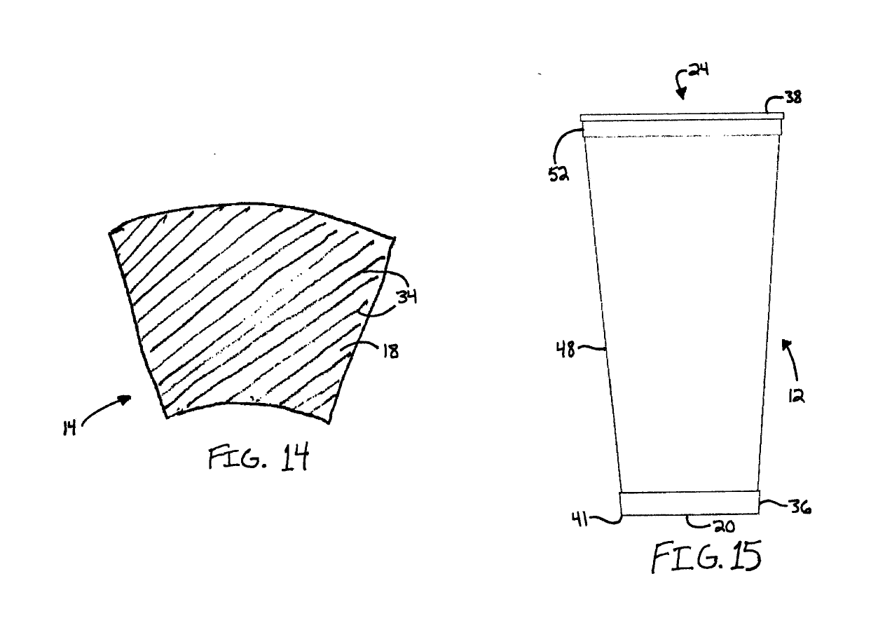

As another example, the preformed container 12 and the optical effect array 14 may include folds to connect to one another. Referring to FIGS. 1-4 and 12, the preformed container 12 may include an upper fold 38 that folds over and engages the optical effect array 14. Alternatively, referring to FIG. 13, the optical effect array 14 may simply abut the upper fold 38, for example, if the preformed container 12 and the optical effect array 14 are connected by a pressure fit. Referring to FIGS. 3, and 15-18, the preformed container 12 may include a base ridge 41 over which the array bottom portion 30 is folded.

Referring again to FIGS. 2-4 and as briefly described above, the container 10 of the present invention thermally insulates substances within the container 10. Specifically, the container 10 includes one or more gaps 44 defined by the preformed container 12 and the optical effect array 14 that thermally insulate substances within the container 10. The gaps 44 may have a width of 0.1 to 2 mm, although this range of dimensions may be varied. In addition, the gaps 44 are preferably air gaps, but may be filled with inert gasses or thermal insulating materials such as foam and the like. The components of the container 10 may be designed in a number of manners to define the gap 44. For example, referring to FIGS. 2, 3, 12, 15, and 16, the gap 44 may be defined by the upper stepped section 52 proximate the upper edge of the preformed container 12. The upper stepped section 52 engages an array upper portion 54. Referring to FIGS. 2 and 3 the upper stepped section 52 may be combined with the array fold 32 to contact the optical effect array 14 and separate one or more recessed surfaces 48 from the array inner surface 18 to define the gap 44.

Referring to FIGS. 17 and 18, as another example, the gap 44 may be defined by the intermediate stepped sections 53 and 55. The intermediate stepped sections 53 and 55 may be combined with the base ridge 41 over which the array bottom portion 30 is folded to separate the array inner surface 18 and the side wall outer surface 28 to define the gap 44.

Referring to FIGS. 2 and 3, as another example, the preformed container 12 may include a plurality of ridges, two of which are indicated by reference 46, and a plurality of recessed surfaces 48, with a single recessed surface 48 positioned between each pair of ridges 46 to define multiple gaps 44. The ridges 46 and the recessed surfaces 48 may define a plurality of curved sections 50 on the side wall 22 that are, for example, substantially u-shaped in a sectional view. The curved sections 50 may also be v-shaped, dimple-shaped, a textured surface, or any other shape that provides space between the array inner surface 18 and the recessed surfaces 48. In addition, and as shown in the figures, the ridges 46 preferably do not extend beyond a plane defined by the upper stepped section 52 and the lower stepped section 36. Further still, the side wall inner surface 26 may have a shape that corresponds to the shape of the ridges 46 and the recessed surfaces 48 such that the side wall 22 has a constant thickness.

Referring to FIGS. 9-11, if included, the ridges 46 and the recessed surfaces 48 there between may be vertical, horizontal, or diagonal features. In addition, the ridges 46 may be discontinuous and/or nonlinear features. Further still, referring to FIG. 7, the portion 40 of the preformed container 12 proximate the seam 42 preferably does not include ridges 46 to provide appropriate location for a connection between the preformed container 12 and the optical effect array 14.

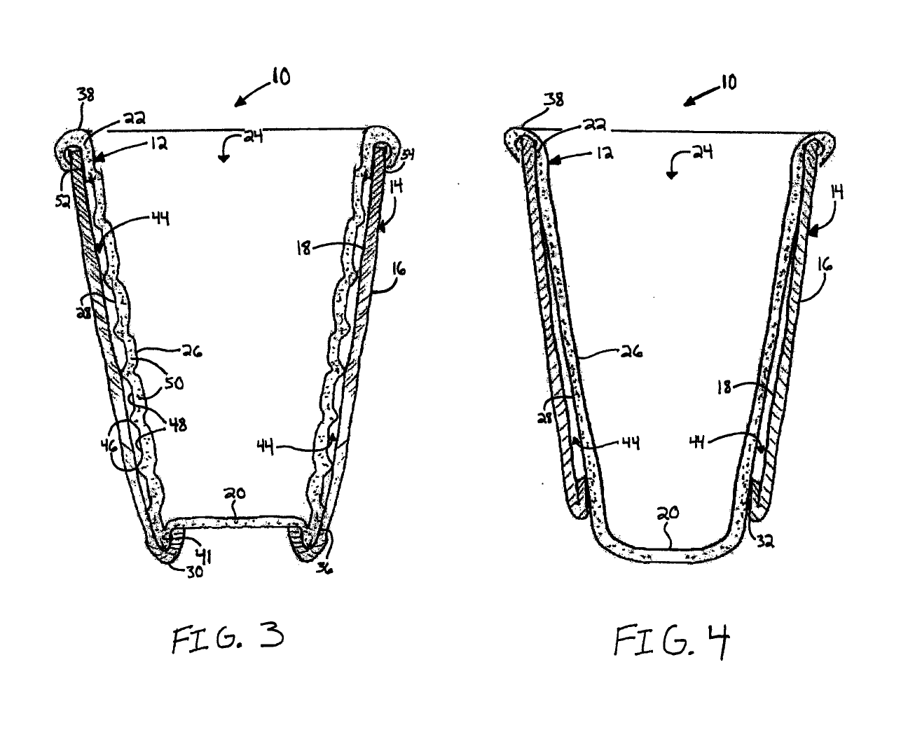

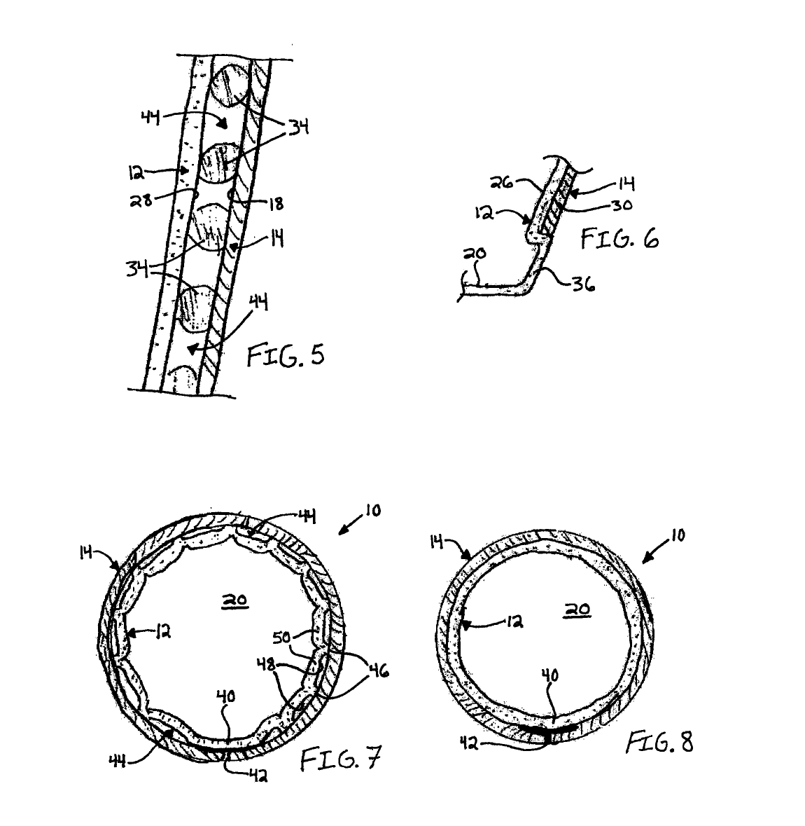

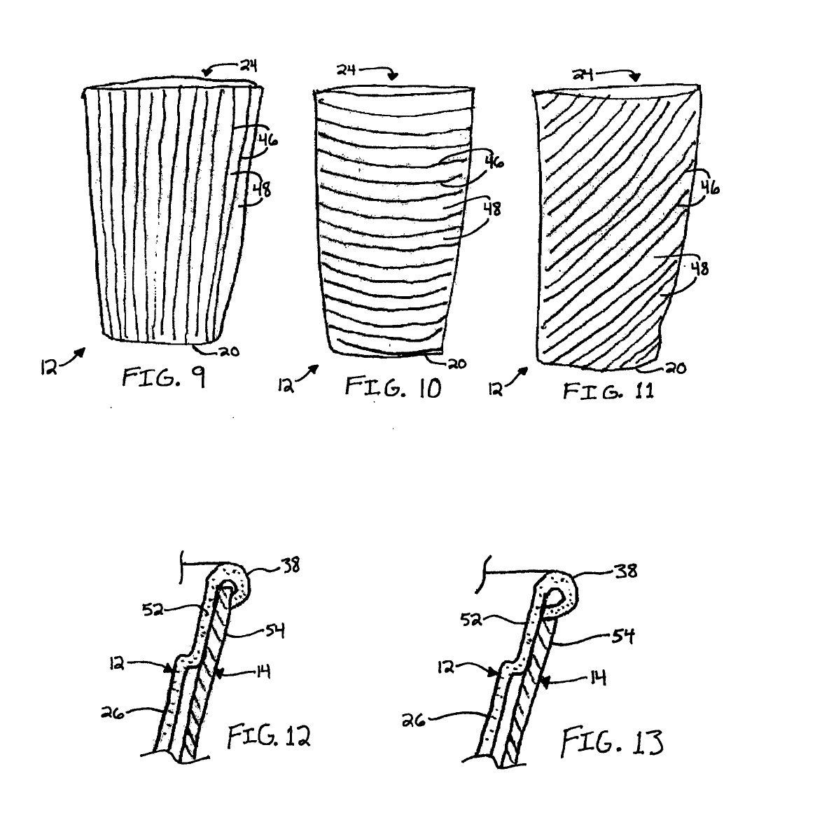

Referring to FIG. 4, the gap 44 may be provided, for example, by including the array fold 32 on the optical effect array 14. The array fold 32 provides a gap 44 that is substantially triangular in shape and tapers from an end proximate the base 20 to a distal end.

As yet another example, referring to FIG. 5, the gap 44 may be defined by the adhesive lines 34 between the side wall outer surface 28 and the array inner surface 18. The adhesive lines 34 preferably have a generally circular cross-sectional shape to define the gap 44, although other shapes are also possible. In addition, the adhesive lines 34 are preferably formed of an adhesive with a relatively low viscosity. The term ‘low viscosity’ in this context should be understood as meaning an adhesive that does not deform substantially when heated and/or subjected to pressure to bond to the preformed container 12 and the optical effect array 14.

In addition, the optical effect container 10 may also include other features without departing from the scope of the invention. For example, the upper fold 38 and adjacent portions of the preformed container 12 may be designed to accommodate a separate cover or lid if the container 10 is to be used as a beverage container. As another example, the optical effect array 14 may be die cut and scored to create a fold-out handle (not shown) for a consumer to grasp. As yet another example, the optical effect array 14 may have an alternative shape, such as an embossed area that creates a depiction of a cartoon character.

The optical effect container 10 is preferably formed as follows. The preformed container 12 is preferably made from a thermoplastic polymeric material using a thermoforming, injection molding, blow molding, vacuum forming, or similar operation. However, the preformed container 12 may be made from paper or plastic/poly-coated paper, for example, if the container 10 is only intended for a single use. The preformed container 12 may also be formed on a container-making machine such as those manufactured by Paper Machinery Corp. of Milwaukee Wis., USA, or Horauf of Donzdorf, Germany. In some embodiments, after the preformed container 12 is formed, the optical effect array 14 is wrapped around the side wall outer surface 28. The optical effect array 14 preferably covers a majority of the side wall outer surface 28, which should be understood as at least the entire height of the side wall 22. However, the optical effect array 14 may cover less of the side wall outer surface 28 or provide a removable sleeve without departing from the scope of the invention. Conversely, the optical effect array 14 may have the shape of a container to completely enclose the preformed container 12.

After the optical effect array 14 has been wrapped around the side wall outer surface 28, the optical effect array 14 and the preformed container 12 may be engaged in one or more of the manners described above. For example, portions of the optical effect array 14 and the preformed container 12 may be ultrasonically welded, adhered, folded, or otherwise configured to engage one another. If the preformed container 12 and the optical effect array 14 are adhered to one another, the adhesive lines 34 are preferably positioned on the array inner surface 18 before the components are connected. However, the adhesive lines 34 may be originally positioned on the preformed container 12.

Alternatively, the optical effect array 14 may be wrapped around a separate mandrel (not shown), for example, if the optical effect array 14 and the preformed container 12 are to be connected by pressure fitting. As a result, the optical effect array 14 may be formed with a smaller dimension, for example, diameter, than the preformed container 12 for effective pressure fitting. After forming the optical effect array 14 on the mandrel, the optical effect array 14 may be slid over and into engagement with the preformed container 12.

The present invention advantageously provides an optical effect container with improved thermal properties due to the presence of a gap and a double-wall design. In addition, the present invention also advantageously provides an optical effect container that may include a preformed container and an optical effect array formed of dissimilar materials.

It is specifically intended that the present invention not be limited to the embodiments and illustrations contained herein, but include modified forms of those embodiments including portions of the embodiments and combinations of elements of different embodiments as come within the scope of the following claims.

1. An optical effect container, comprising:
a preformed container including:
a base;
a side wall connected to the base and defining a container opening; and
an optical effect array adjacent the side wall,
the preformed container and the optical effect array defining a gap therebetween.

2. The optical effect container of claim 1, wherein the gap is defined by an array fold of the optical effect array.

3. The optical effect container of claim 1, wherein the gap is defined by a plurality of ridges of the preformed container.

4. The optical effect container of claim 1, wherein the gap is defined by a plurality of curved sections of the side wall.

5. The optical effect container of claim 1, wherein the gap is defined by an upper stepped section proximate an upper edge of the preformed container.

6. The optical effect container of claim 1, wherein the preformed container includes an upper fold adjacent both an inner surface and an outer surface of the optical effect array.

7. The optical effect container of claim 1, wherein the gap is an air gap.

8. A method of forming an optical effect container, comprising the steps of:
forming a container having an outer surface;
providing an optical effect array;
positioning the optical effect array adjacent the outer surface;
securing a portion of the optical effect array to the outer surface; and
forming a gap between the optical effect array and the outer surface.

9. The method of claim 8, wherein the container is formed in a thermoforming process.

10. The method of claim 8, wherein the portion of the optical effect array is adhered to the outer surface.

11. The method of claim 8, wherein the portion of the optical effect array is ultrasonically welded to the outer surface.

12. The method of claim 8, wherein the portion of the optical effect array is secured to the outer surface by folding an edge of the container over the optical effect array.

13. The method of claim 8, wherein the portion of the optical effect array is secured to the outer surface by folding the portion of the optical effect array over a second portion of the optical effect array and one of adhering and ultrasonically welding the portion of the optical effect array to the outer surface.

14. The method of claim 8, wherein the container includes a base ridge and the portion of the optical effect array is folded over the base ridge.

15. The method of claim 8, wherein the container includes a base and a lower stepped section proximate the base, and further comprising the step of moving the optical effect array into engagement with the lower stepped section.

16. The method of claim 8, wherein the portion of the optical effect array is proximate a seam of the optical effect array, and the portion of the optical effect array is one of adhered and ultrasonically welded to the outer surface.

17. An optical effect container, comprising:
a container having an outer surface; and
an optical effect array having an inner surface adjacent a portion of the container, the inner surface and the outer surface defining a gap between the container and the optical effect array.

18. The optical effect container of claim 17, wherein the outer surface includes a plurality of ridges and a plurality of recessed surfaces to define the gap.

19. The optical effect container of claim 18, wherein the outer surface includes a non-recessed surface proximate a seam of the optical effect array.

20. The optical effect container of claim 17, wherein the optical effect array is a lenticular array.
